(19) United States
(12) Patent Application Publication
(10) Pub. No.: US 2026/0146850 A1
(43) Pub. Date: May 28, 2026

(54) LATERAL SHEARING INTERFEROMETRY FOR SURFACE PROFILE MEASUREMENT OF PATTERN WAFERS

(71) Applicant: KLA Corporation, Milpitas, CA (US)

(72) Inventors: Qiang Zhao, Milpitas, CA (US); Wenhua Zhu, Albany, CA (US)

(21) Appl. No.: 19/320,406

(22) Filed: Sep. 5, 2025

Related U.S. Application Data
(60) Provisional application No. 63/723,592, filed on Nov. 22, 2024.

(51) Int. Cl. G01B 11/24; G01B 9/02; G01B 9/02015

(52) U.S. Cl. CPC G01B 11/2441; G01B 9/02022; G01B 9/02041; G01B 2210/56; G01B 2290/70

(57) ABSTRACT

A system may include a lateral shearing interferometer. The lateral shearing interferometer may enable measuring a surface profile of a sample, such as the pattern wafers, using reflected light from the sample. The reflected light may be reflected at a grazing incidence angle. A controller may receive images from the lateral shearing interferometer and measure the surface profile. The controller may measure the surface profile by reconstructing a phase of the reflected light from the images. The controller may reconstruct the phase using spatial reconstruction or time-domain reconstruction. The gratings may allow the controller to measure the edge roll-off in one or two dimensions. The controller may also calibrate the grazing incidence angle and determine refractive indices of thin-films on the sample. The controller may also perform full measurements of the surface profile using line beams, rectangular beams, or full-sample beams.

### CROSS-REFERENCE

The present application claims the benefit under 35 U.S.C. § 119 of U.S. Provisional application 63/723,592, filed on Nov. 22, 2024, titled “Lateral Shearing Interferometry Apparatus for Surface Profile Measurement of Pattern Wafers”, which is incorporated herein by reference in the entirety.

### TECHNICAL FIELD

The present disclosure generally relates to measuring contours or curvatures using interferometry, and more particularly to shearing interferometers.

### BACKGROUND

Silicon wafers that serve as the substrates of semiconductor devices must be extremely flat across the whole surface. Currently, the global flatness across an entire wafer and the site flatness in an area of a device must be <100 nm and <20 nm, respectively. The global and site flatness of silicon wafers within these tight control specifications can help to assure the full wafers of successful lithographic processing. In addition to the flatness, there is a strong demand to reduce the edge roll off (ERO) of the wafer over the process flow to achieve better device yield and performance in the wafer. The edge roll off may degrade due to inappropriate polishing and etching process conditions over the process flow.

For bare silicon wafers, wafer surface edge profile has been routinely conducted for wafer quality assurance through the wafer manufacturing process and wafer reclaim process. Due to free of pattern structures and other thin film stacks on the wafer, the wafer edge profile measurement technology is relatively straight-forward and has many technology options available. The surface scanning with small spot laser beam under focus can measure surface profile down to sub-micrometer level resolution including wafer edge profile. With low frequency information filtering, the surface roughness at micrometer level can also be measured. The other commonly used bare silicon wafer edge profile measurement is wafer side imaging-based technology using a detector to collect wafer edge side image. The obtained wafer edge side image can be analyzed automatically by the algorithm to provide wafer edge profile details and wafer edge profile measurement results including ERO. Other wafer edge profile measurement technologies reported include white light interferometry (WLI), chromatic confocal sensor (CCS), grading incidence interferometry (GII), Shack-Hartmann microlens array, Fizeau interferometry, coherent gradient sensing (CGS), Lateral Differential Interferometry with high AOI, and spectral interferometry.

Cutting-edge technology has pushed the processes from Fin field effect transistor (FinFET) to nanosheet GAA (Gate all around) transistor, which puts forward higher requirement on transistor interconnection in back end of line (BEOL) and, the latest solution is backside power distribution network (BS-PDN) allowing to separate the signal interconnection on the product wafer's front side with regular BEOL interconnection and power distribution network on the product wafer's back side with backside metal interconnection (BSMI). During BS-PDN fabrication, product wafer front surface must be bonded to another silicon carrier wafer for PDN process and the product wafer surface profile and edge quality are critical. Sub-micron wafer edge roll-off, defects, such as scratches, particles, and residues on the wafer surface, particularly in the wafer edge area, will seriously affect the quality of process steps such as deposition, etching, and wafer bonding, resulting in yield loss and even wafer scraps. To make sure good wafer bonding between product wafer with the other carrier wafer, the product wafer ERO must be controlled within an optimal range by an edge rebuilding process consisting of a few depositions and chemical mechanical polishing (CMP) steps including wafer bevel dielectric deposition. The wafer ERO measurement is critical for the process control of wafer ERO fixing process. The other potential wafer bonding process requiring low ERO control is 4F2 (square) DRAM fabrication which has a vertical cell transistor. To solve the interconnection congestion, Bit line and capacitor are made on top and bottom ends of the vertical transistor. In one kind of process flow of 4F2 DRAM, Bit line is made first on the top of vertical transistor and the capacitor on the other end of the transistor after wafer bonding on a carrier wafer and wafer polishing back. As BS-PDN, the 4F2 DRAM process may also require quality bonding between DRAM and carrier wafer at the edge, and a demanding wafer edge roll-off control within edge region such as 5 mm or less is needed.

Automated wafer edge profile metrology and defect inspection have been widely investigated and applied in the production lines of silicon wafer manufacturing, and more demanding process control on product wafers is needed in the latest semiconductor manufacturing including both integrated circuit (IC) device fabrication and IC device advanced packaging as well. For BS-PDN process and 4F2 DRAM process, product wafer front surface for dielectric bonding with another carrier wafer is required to be with appropriate flatness across the whole wafer and sub-micrometer or even deep sub-micrometer wafer ERO as well. However, wafer ERO measurement of product wafer for BS-PDN and 4F2 DRAM wafer bonding is much more difficult than bare silicon wafers due to its possible thin film stack, typically transparent, and underneath pattern structures. For most wafer edge metrology technology available including focus based, side or front imaging based, chromatic confocal sensor based, single wavelength or white light interferometry based, and other interferometry based known edge profile metrology, the pattern structure and transparent thin film stacks both have adversely affected the wafer ERO measurement. The wafer ERO metrology performance of GRR (gauge repeatability and reproducibility) is required to meet <10% of wafer sub-micrometer ERO control specification to be used as a viable process control solution for wafer edge profile optimization process.

Over the semiconductor manufacturing process of an integrated circuit (IC) device, the wafer edge profile is subject to additional variation and uncertainty due to lithography photo resist edge bead removal (EBR), and differential process impact between wafer edge and the rest of the area in the process of etch, deposition, chemical-mechanical polishing (CMP), etc. With the appearance of new process such as BS-PDN for higher interconnection density in GAA transistor technology node production and 4F2 DRAM with bit line and capacitor made on different sides of vertical transistor for lower interconnection congestion, demanding wafer edge roll-off control is required to assure high quality wafer bonding between front side of product wafer with a carrier wafer. BS-PDN and 4F2 DRAM wafer bonding has much higher level of needs for tight wafer edge profile control compared to the other wafer bonding cases already adopted by semiconductor industry including CMOS image sensor (CIS) and 3D NAND flash wafers bonding to another logic control and/or memory wafers.

Several wafer edge profile metrologies have been reported to be adopted by semiconductor industry for the process control. However, all these technologies have some critical concerns and none of them could be used for sub-micrometer and deep sub-micrometer wafer edge roll-off (ERO) process control of product wafers in semiconductor device fabs or advanced packaging fabs. For the various optical-based wafer edge profile metrologies, the measurement impact by pattern structured and transparent dielectric films stacks on the wafer surface are too significant to be adopted as high resolution ERO metrology solution for product wafers with demanding ERO control such as the wafer bonding for BS-PDN and 4F2 DRAM.

Atomic force microscope (AFM) is a high-resolution wafer edge roll-off (ERO) measurement technology which has extremely high vertical resolution (under nanometer). However, AFM has many critical concerns preventing the AFM from adoption in semiconductor fab for high resolution wafer ERO measurement due to the low through-put, tip wearing and damage tendency, and measurement baseline maintenance difficulty. Additional AFM technology concern on the wafer ERO measurement for demanding wafer bonding is being a non-contact metrology method.

Therefore, it would be advantageous to provide a device, system, and method that cures the shortcomings described above.

### SUMMARY

A system is described, in accordance with one or more embodiments of the present disclosure. The system may include: a light source configured to generate illumination, wherein the illumination is directed to a sample along an illumination path and lands on a surface of the sample at an angle of incidence, wherein the angle of incidence is at grazing incidence, wherein the illumination reflects from the sample as reflected light encoding a surface profile of the surface in a phase of the reflected light, wherein the surface profile includes an edge roll-off of an edge of the sample; a stage configured to support the sample; a lateral shearing interferometer including: a grating, wherein the reflected light is directed from the sample to the grating along an imaging path, wherein the grating diffracts the reflected light as diffracted light; and a detector, wherein the diffracted light is directed from the grating to the detector along the imaging path, wherein the detector is configured to generate images of the diffracted light; and a controller, wherein the controller includes one or more processors and memory, wherein the one or more processors are configured to execute program instructions maintained on the memory causing the controller to: receive the images from the detector; and measure the surface profile and the edge roll-off by reconstructing the phase of the reflected light from the images.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 illustrates a partial side view of a sample with an edge roll-off, in accordance with one or more embodiments of the present disclosure.

FIG. 2 illustrates a simplified block diagram of a system with a lateral shearing interferometer configured to measure the edge roll-off of the sample, in accordance with one or more embodiments of the present disclosure.

FIGS. 3A-3B illustrates graphs, in accordance with one or more embodiments of the present disclosure.

FIG. 4 illustrates gratings of the lateral shearing interferometer of the system, in accordance with one or more embodiments of the present disclosure.

FIG. 5 illustrates a simplified block diagram of the system with the lateral shearing interferometer rotated at a tilt angle, in accordance with one or more embodiments of the present disclosure.

FIG. 6A-6D illustrates a top view of the sample with different beam widths of illumination of the system, in accordance with one or more embodiments of the present disclosure.

FIG. 7 illustrates a simplified block diagram of the system with a pair of the lateral shearing interferometers, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to a Lateral Shearing Interferometry Apparatus for Surface Profile Measurement of Pattern Wafers. A system includes a lateral shearing interferometer. The lateral shearing interferometer may enable measuring a surface profile of a sample, such as the pattern wafers, using reflected light from the sample. The reflected light may be reflected at a grazing incidence angle. A controller may receive images from the lateral shearing interferometer and measure the surface profile. The controller may measure the surface profile by reconstructing a phase of the reflected light from the images. The controller may reconstruct the phase using spatial reconstruction or time-domain reconstruction. The gratings may allow the controller to measure the edge roll-off in one or two dimensions. The controller may also calibrate the grazing incidence angle and determine refractive indices of thin-films on the sample. The controller may also perform full measurements of the surface profile using line beams, rectangular beams, or full-sample beams.

U.S. Pat. No. 7,324,917B2, titled “Method, system, and software for evaluating characteristics of a surface with reference to its edge”; U.S. Pat. No. 7,369,251B2, titled “Full-field optical measurements of surface properties of panels, substrates and wafers”; U.S. Pat. No. 8,902,429B1, titled “Focusing detector of an interferometry system”; U.S. Pat. No. 9,784,570B2, titled “Polarization-based coherent gradient sensing systems and methods”; U.S. Pat. No. 9,935,022B2, titled “Systems and methods of characterizing process-induced wafer shape for process control using CGS interferometry”; U.S. Pat. No. 10,330,608B2, titled “Systems and methods for wafer surface feature detection, classification and quantification with wafer geometry metrology tools”; U.S. Pat. No. 10,809,055B2, titled “Apparatus and method for measuring topography and gradient of the surfaces, shape, and thickness of patterned and unpatterned wafers”; U.S. Pat. No. 11,049,720B2, titled “Removable opaque coating for accurate optical topography measurements on top surfaces of transparent films”; U.S. Pat. No. 11,609,506B2, titled “System and method for lateral shearing interferometry in an inspection tool”; are each incorporated herein by reference in the entirety.

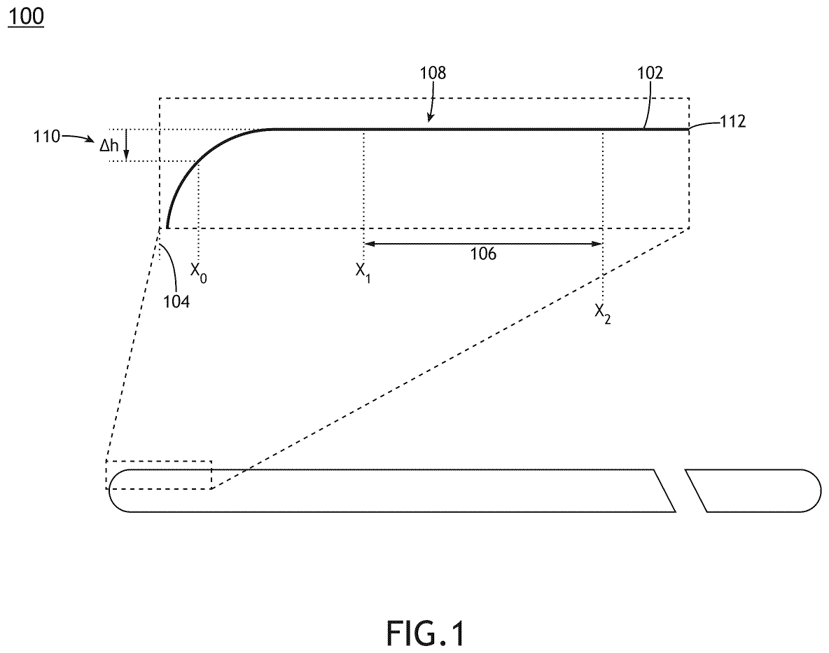

FIG. 1 illustrates a sample 100, in accordance with one or more embodiments of the present disclosure. The sample 100 may include any suitable sample. For example, the sample 100 may be, but is not limited to, a wafer, a reticle, a mask, and the like. The wafer may be a product wafer, a pattern wafer (e.g., a high-volume manufacturing (HVM) production pattern wafers), a device wafer, or the like. For example, the sample 100 may be a BS-PDN wafer or a 4F2 DRAM wafer. The sample 100 may include a surface 102, an edge 104, a reference area 106, a surface profile 108, an edge roll-off 110, a thin-film 112, and the like.

The sample 100 may include the surface 102. The surface 102 may be a top surface and/or a bottom surface of the sample 100. The surface 102 may be defined by a thin-film 112. The thin-film 112 may be a thin-film stack (e.g., a transparent thin film stack), a pattern structure, a coating, or the like. The thin-film 112 may be underneath the surface 102. The thin-film 112 may raise challenges when performing metrology on the sample 100 to measure the surface profile 108 and/or the edge roll-off 110. The sample 100 may also include the edge 104. The edge 104 may be a continuous curved edge defining a circle shape of the sample 100.

The surface 102 may include the surface profile 108. The surface profile 108 may also be referred to as a surface metrology, a surface topography, a surface height, or the like. The surface profile 108 may vary across the width and/or length of the surface 102. The surface profile 108 may indicate the local flatness and/or the global flatness of the sample 100.

The surface profile 108 may include the edge roll-off 110 of the sample 100. The edge roll-off 110 may be the surface height difference (Δh) between the reference area 106 and an edge exclusion position (X0). The reference area 106 may be between a first reference position (X1) and a second reference position (X2). For example, the reference area 106 may be between 5 mm and 10 mm from the edge 104. The edge exclusion position (X0) may be offset from the edge 104. For example, edge exclusion position (X0) may within 0.5 mm to the edge 104, although zero edge exclusion of the edge exclusion position (X0) is desired (e.g., such that the edge exclusion position (X0) would be aligned at the edge 104).

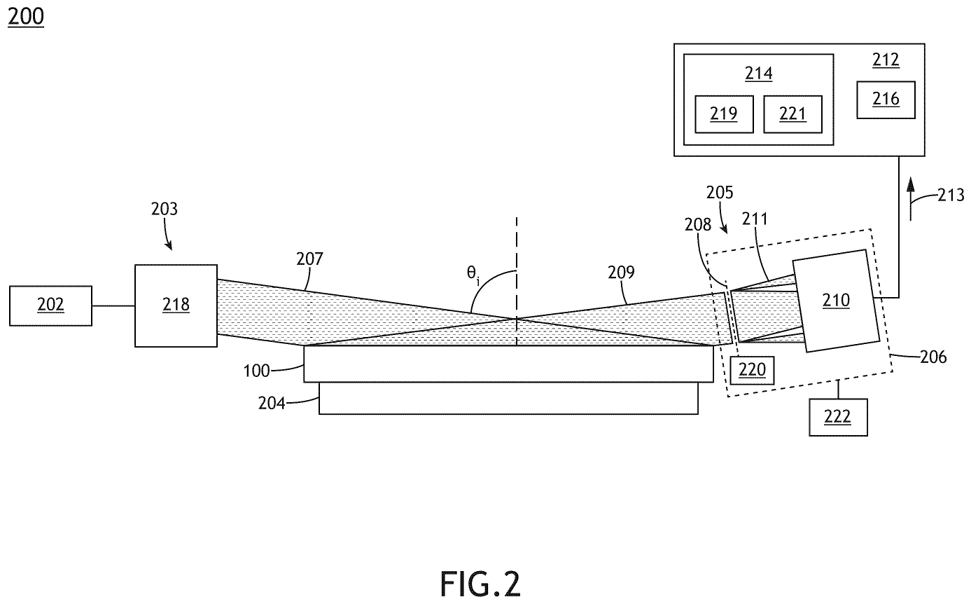

FIG. 2 illustrates a system 200, in accordance with one or more embodiments of the present disclosure. The system 200 may also be referred to as a metrology system, an LSI metrology system, a grazing-incidence LSI metrology system, or the like. The system 200 may include one or more components, such as, but not limited to, a light source 202, an illumination path 203, a stage 204, an imaging path 205, a lateral shearing interferometer 206 (LSI), a grating 208, a detector 210, a controller 212, processors 214, and/or a memory 216, illumination optics 218, a grating actuator 220, an LSI actuator 222, and the like.

The system 200 may measure the surface profile 108 of the sample 100. For example, the system 200 may measure the edge roll-off 110 of the sample 100. The lateral shearing interferometer 206 and/or the controller 212 may measure the edge roll-off 110. The system 200 may measure the edge roll-off 110 by determining the surface height difference (Δh) from the phase (φ) of the reflected light 209 at grazing incidence through encoding the surface height difference (Δh) into a lateral shearing interferogram in the images 213 and measuring the surface height difference (Δh) from the interferogram.

The system 200 may include the light source 202. The light source 202 may be configured to generate the illumination 207. The light source 202 may include any suitable light source configured to generate the illumination 207, such as, but not limited to, a laser light source, a LED light source, or the like. The laser light source may be a single mode or multiple mode laser source, a solid-state laser, a fiber laser source, a tunable laser, a supercontinuum laser, or the like. The light source 202 may include filters (not depicted) for wavelength selection.

The illumination 207 may also be referred to as probe light, a light beam, or the like. The illumination 207 may include one or more optical properties. The optical properties may include optical properties of the illumination 207 per se and/or of the beam of the illumination 207 as manipulated by the illumination optics 218. For example, the optical properties of the illumination 207 may include a wavelength (λ), propagation angle (e.g., collimation), a coherence length, an intensity profile, a polarization, a beam width 215, optical mode(s), and the like. The illumination 207 may include any suitable wavelength (λ). For example, the wavelength (λ) of the illumination 207 be an ultraviolet wavelength, a visible wavelength, and/or an infrared wavelength. The illumination 207 may include any range of selected wavelengths. The light source 202 may include a spectrally-tunable illumination source to generate illumination 207 having a tunable wavelength. The illumination 207 may be collimated when landing on the sample 100. For example, the light source 202 may generate the illumination 207 as collimated light (e.g., the light source 202 may be a collimated light source). By way of another example, the illumination optics 218 may collimate the illumination 207. The illumination 207 may or may not coherent. For example, a coherence length of the illumination 207 may be less than, equal to, or greater than the diameter of the sample 100. The coherence length of the illumination 207 may be less than the diameter of the sample 100 without affecting the performance of the system 200 because the illumination 207 may function using common-path interferometry. The illumination 207 may include a selected intensity profile. For example, the illumination 207 may include a Gaussian distribution or a non-Gaussian distribution (e.g., a flat-top beam), or the like. The illumination 207 may include the beam width 215. The beam width 215 may also be referred to as a linewidth, a beam diameter, or the like. The beam width 215 of the illumination 207 may be a portion of the width of the sample 100 and/or a full width of the sample 100. The illumination 207 may include one or more optical modes. The Illumination optics 218 may configure the optical modes of the illumination 207. For example, the illumination optics 218 may include single-mode and/or multi-mode fibers for configuring the optical modes of the illumination 207.

The system 200 may include the illumination path 203. The system 200 may direct the illumination 207 to the sample 100. For example, the system 200 may direct the illumination 207 to the sample 100 along the illumination path 203. The illumination path 203 may be an optical path for providing the illumination 207 to the sample 100. The illumination path 203 may include the illumination optics 218 which direct the illumination 207 to the sample 100. The illumination optics 218 may include one or more optical components. The illumination optics 218 may be suitable for modifying and/or conditioning the illumination 207.

The illumination 207 may land on the sample 100 at an angle of incidence (θᵢ) (illumination AOI). The illumination 207 may land on the surface 102 of the sample 100. The angle of incidence (θᵢ) may be defined relative to surface normal of the sample 100. The angle of incidence (θᵢ) may be at grazing incidence. The angle of incidence (θᵢ) may be any suitable grazing incidence angle. The angle of incidence (θᵢ) may be close to 90 degrees. The angle of incidence (θᵢ) may be offset from 90 degrees, to allow the illumination 207 to land on the sample 100. For example, the angle of incidence (θᵢ) may be between 80 degrees and 89.5 degrees. By way of another example, the angle of incidence (θᵢ) may be between 85 degrees and 89.5 degrees. By way of another example, the angle of incidence (θᵢ) may 87 and 89 degrees. By way of another example, the angle of incidence (θᵢ) may be 88 degrees.

The illumination 207 may land on the sample 100 and extend across the length of the sample 100. For example, the illumination 207 may extend between opposing sides of the edge 104 of the sample 100 (e.g., from a first side of the edge 104 to an opposing side of the edge 104). For instance, the illumination 207 may extend across the length of a 300 mm wafer. Extending across the length of the sample 100 with the illumination 207 may allow the system 200 to simultaneously measure the surface profile 108 including the edge roll-off 110 on both edges of the wafer for double throughput (e.g., as compared to measuring the edge roll-off 110 of one edge at a time). The angle of incidence (θᵢ) being at grazing incidence may cause the illumination 207 to extend across the length of the sample 100. For example, the angle of incidence (θᵢ) being at grazing incidence may cause the illumination 207 to extend across the length of the sample 100 even if the beam width 215 is only the portion of the width of the sample 100. With the angle of incidence (θᵢ) being at grazing incidence, the illumination 207 may cover full 300 mm wafer diameter and provide simultaneous measurements of the edge roll-off 110 on both sides of the wafer edge.

The system 200 may include the stage 204. The stage 204 may support the sample 100. The stage 204 may be an actuatable stage. The sample 100 may be actuated under the illumination 207 by the stage 204. The stage 204 may include any device suitable for positioning and/or rotating the sample 100 under the illumination 207. For example, the stage 204 may include any combination of linear translation stages, rotational stages, tip/tilt stages, or the like. For example, the stage 204 may include, but is not limited to, one or more translational stages suitable for translating the sample 100 along one or more linear directions (e.g., x-direction, y-direction, and/or z-direction). By way of another example, the stage 204 may include, but is not limited to, one or more rotational stages suitable for rotating the sample 100 along a rotational direction. By way of another example, the stage 204 may include, but is not limited to, a rotational stage and a translational stage suitable for translating the sample 100 along a linear direction and/or rotating the sample 100 along a rotational direction. The stage 204 may also adjust the height of sample 100 to maintain a focus of the illumination 207 on the sample 100.

The illumination 207 may reflect from the sample 100 as the reflected light 209. The reflected light 209 may also be referred to as a reflected light beam. The reflected light 209 may reflect from the sample 100 at the angle of incidence (θᵢ). The reflected light 209 may reflect from opposing sides of the edge 104 and the length therebetween of the sample 100.

The reflected light 209 that reflects from the sample 100 may be distorted according to the surface profile 108 of the surface 102. For example, the reflected light 209 may encode the surface profile 108 of the surface 102 in the phase (φ) of the reflected light 209. The surface profile 108 may be encoded in the phase (φ) of the reflected light 209 due to a difference in optical path length caused by the surface profile 108. The distortion according to the surface profile 108 may be the signal of interest. For example, the edge roll-off 110 may induce the phase difference (Δφ) in the reflected light 209.

A portion of the reflected light 209 may also reflect from underneath the surface 102. For example, the portion of the reflected light 209 may reflect from thin-film 112 underneath the surface 102. The reflectance of the surface 102 may be the signal containing the information of the surface profile 108 whereas the reflectance from underneath the surface 102 may be the noise affecting the measurement of the surface profile 108.

The angle of incidence (θᵢ) being at grazing incidence may reduce an impact of transparent films and/or a pattern structure of the sample 100 on the reflected light 209. A high signal-to-noise ratio may be achieved with the angle of incidence (θᵢ) at grazing incidence. The angle of incidence (θᵢ) being at grazing incidence may reduce the reflected light 209 from the other interfaces other than the surface 102 and avoid the adverse impact of thin-film 112 on the surface profile 108 and the edge roll-off 110. The total reflectance of the surface 102 may be determined by the superposition of both the surface 102 and underneath structure reflectance. The Fresnel equation indicates that the reflectance from the surface 102 may approach to 100% at grazing incidence illumination. Theoretically, 100% reflectance can be achieved at 90 degrees of angle of incidence (θᵢ) with the reflectance from the thin-film 112 approaching to 0% at grazing incidence illumination. At least 90% of the illumination 207 may reflect as the reflected light 209 from the surface 102. Less than 10% of the illumination 207 may reflect as the reflected light 209 from the thin-film 112 below the surface 102. The angle of incidence (θᵢ) being at grazing incidence may optimize a signal-to-noise ratio (SNR) of the reflected light 209 by getting more than 90% reflectance from the surface 102 and less than 10% reflectance from underneath the surface 102. Thus, the metrology of the surface profile 108 by the system 200 may result in a least impact from the thin-film 112, even if the thin-film 112 is transparent or translucent.

The system 200 may include the imaging path 205. The system 200 may direct the reflected light 209 from the sample 100 to lateral shearing interferometer 206 along the imaging path 205. For example, the system 200 may direct the reflected light 209 from the sample 100 to the grating 208 and/or may direct the diffracted light 211 from the grating 208 to the detector 210. For example, the system 200 may direct the reflected light 209 to the grating 208 and/or may direct the diffracted light 211 to the detector 210 along the imaging path 205. The imaging path 205 may be an optical path for directing the reflected light 209 and/or the diffracted light 211. The imaging path 205 may include the lateral shearing interferometer 206, the grating 208, the detector 210, and/or one or more imaging optics (not depicted). The imaging optics may include one or more optical components. The imaging optics may be suitable for modifying and/or conditioning the reflected light 209 and/or the diffracted light 211.

The system 200 may include the lateral shearing interferometer 206. The lateral shearing interferometer 206 may also be referred to as a lateral shearing interferometry apparatus, an LSI arm, or the like. The lateral shearing interferometer 206 may include the grating 208 and the detector 210.

The grating 208 may be disposed in the path of the reflected light 209. The grating 208 may diffract the reflected light 209 as the diffracted light 211. The grating 208 may include any suitable grating for diffracting the reflected light 209 as the diffracted light 211. For example, the grating 208 may be a transmissive grating, a reflective grating, or the like. In embodiments, the grating 208 is the transmissive grating. The transmissive grating may be beneficial for aligning the detector 210 with the diffracted light 211, due to the angle of incidence (θᵢ) being at grazing incidence. For example, the reflective grating may cause issues with aligning the detector 210 with the diffracted light 211 without the detector 210 abutting the sample 100. The grating 208 may include diffracting elements 217. The diffracting elements 217 may diffract the reflected light 209 as the diffracted light 211. The diffracting elements 217 may be lateral displaced replicas which diffract the reflected light 209 as the diffracted light 211.

The detector 210 may be disposed in the path of the diffracted light 211. The detector 210 may detect the diffracted light 211. The detector 210 may generate images 213 of the diffracted light 211. The detector 210 may include any suitable detector configured to generate the images 213. For example, the detector 210 may include a charge coupled device (CCD) detector, a complementary metal-oxide-semiconductor (CMOS) detector, a shearing camera, a high-resolution light sensor, and the like. The detector 210 may include a width and/or a length. The width and length may refer to respective of the widths and lengths across which the detector 210 may detect the diffracted light 211. The detector 210 may be a one-dimensional (1D) detector or two-dimensional (2D) detector. For example, the one-dimensional detector may detect the images 213 as line images along the length of the sample 100. By way of another example, the two-dimensional detector may detect the images 213 as images along the length of the sample 100 and along the width of the illumination 207.

The diffracted light 211 may superpose an interferogram on the detector 210. The interferogram may be a lateral-shearing interferogram. The reflected light 209 from the surface 102 may diffract from the grating 208 as the diffracted light 211 and superpose on the detector 210 forming the lateral-shearing interferogram with the surface profile 108 encoded as the phase difference (Δφ). The interferogram may include fringes. The fringes may represent the phase difference (Δφ).

The system 200 may include the controller 212. The controller 212 may include the processors 214 and/or memory 216. The memory 216 may maintain program instructions which may be executable by the processors 214, causing the controller 212 to perform any of the various functions of the controller 212.

The controller 212 may be configured to control one or more components of the system 200. For example, the controller 212 may be configured to control the light source 202, the illumination path 203, the stage 204, the imaging path 205, the lateral shearing interferometer 206, the illumination 207, the grating 208, the reflected light 209, the detector 210, the diffracted light 211, illumination optics 218, the grating actuator 220, the LSI actuator 222, or the like. The controller 212 may receive the images 213 from the detector 210. The controller 212 may control the various components based on the images 213.

The controller 212 may measure the surface profile 108 and/or the edge roll-off 110 from the images 213. For example, the controller 212 measure the surface profile 108 and/or the edge roll-off 110 by reconstructing the phase (φ) of the reflected light 209.

The controller 212 may reconstruct the phase (φ) of the reflected light 209 from the images 213. The reconstruction of the phase (φ) of the reflected light 209 may represent the surface profile 108 and/or the edge roll-off 110. The controller 212 may be configured to reconstruct the phase (φ) of the reflected light 209 from the images 213 using any suitable technique. For example, the controller 212 may be configured to reconstruct the phase (φ) of the reflected light 209 using a spatial reconstruction 219 and/or a time-domain reconstruction 221.

The spatial reconstruction 219 may reconstruct the phase (φ) of the reflected light 209 from the images 213 in a spatial domain. For the spatial domain reconstruction, the system 200 may use one of the images 213 with the interferogram to reconstruct the phase (φ). The controller 212 may cause the detector 210 to generate one of the images 213. The controller 212 may then reconstruct the phase (φ) by performing a Fourier transform on the one of the images 213 and measure the fundamental frequency. The controller 212 may reconstruct the phase (φ) using the spatial reconstruction 219 at a resolution of 1/20th of wavelength (λ) of the illumination 207. The controller 212 may then calculate the surface height difference (Δh) from the phase (φ) which is reconstructed using the spatial reconstruction 219. The controller 212 may calculate the surface height difference (Δh) from the phase (φ) with a resolution of N/cos (θᵢ). For example, for the angle of incidence (θᵢ) at 88 degrees and the wavelength (λ) at 405 nm, the resolution is calculated as 290 nm.

The time-domain reconstruction 221 may reconstruct the phase (φ) of the reflected light 209 from the images 213 in a time domain. The time-domain reconstruction 221 may also be referred to as a phase-stepping method 302. For the time-domain reconstruction 221, the system 200 may use multiple of the images 213 with the interferograms to reconstruct the phase (φ). The controller 212 may cause the detector 210 to generate multiple of the images 213. The controller 212 may also cause the grating actuator 220 to laterally shift the grating 208 between one or more periods generating the images 213. The grating actuator 220 may include a piezo-actuator or the like. The grating actuator 220 may laterally shift the grating 208 relative to the reflected light 209. The grating actuator 220 may laterally shift the grating 208 by a fraction of the grating period of the grating 208 when generating each of the images 213. The laterally shift the grating 208 by the fraction of the grating period may be less than the width of each of the diffracting elements 217 of the grating 208. For example, the grating 208 may be laterally shifted by between two and twenty steps of the diffracting elements 217 within one period of generating each of the images 213 (e.g., laterally shifting by one-half to one-twentieth of the diffracting elements 217 for each of the images 213). Each of the images 213 may have the interferogram with fringes which are displaced in the lateral direction due to the grating actuator 220 laterally shifting the grating 208. The controller 212 may reconstruct the phase (φ) based on the lateral shifting of the interferogram with the fringes which are displaced in the lateral direction in the images 213. The controller 212 may reconstruct the phase (φ) based on the lateral shifting using any suitable algorithm, such as, but not limited to, a least-square method, iterative methods, or the like. The controller 212 may reconstruct the phase (φ) using the time-domain reconstruction 221 at a resolution of 1/200th of wavelength (λ) of the illumination 207. The controller 212 may then calculate the surface height difference (Δh) from the phase (φ) which is reconstructed using the time-domain reconstruction 221. The controller 212 may calculate the surface height difference (Δh) from the phase (φ) with a resolution of 20 nm for the angle of incidence (θᵢ) at 88 degrees and the wavelength (λ) at 405 nm.

The system 200 may be configured between the spatial reconstruction 219 and the time-domain reconstruction 221. The system 200 may be configured between the spatial reconstruction 219 and the time-domain reconstruction 221 for different use cases with different metrology resolution requirements. The spatial reconstruction 219 and the time-domain reconstruction 221 may also be referred to as respective of a low-resolution mode and a high-resolution mode. For example, the time-domain reconstruction 221 may reconstruct the phase (φ) of the reflected light 209 with higher resolution than the spatial reconstruction 219. However, the spatial reconstruction 219 may reconstruct the phase (φ) of the reflected light 209 more quickly than the time-domain reconstruction 221.

The system 200 may measure the surface profile 108 of the sample 100 using the reconstruction of the phase (φ). The lateral shearing interferometer 206 and the controller 212 may measure the surface profile 108 of the sample 100. The controller 212 may calculate the surface height difference (Δh) from the phase (φ). The surface height difference (Δh) may include the surface profile 108 and/or the edge roll-off 110. For measuring the edge roll-off 110, the phase difference (Δφ) between the edge 104 and the reference area 106 may be reconstructed. The reference area 106 may be between 5 mm and 10 mm away from the edge 104. The phase difference (Δφ) may be related to the surface height difference (Δh) by the equation:

$$Δφ = \frac{4 πΔ h cos {θ}_{i}}{λ} \qquad ( 1 )$$

where Δφ is the phase difference (Δφ); θᵢ is the angle of incidence (θᵢ) of the illumination 207; λ is the wavelength (λ) of the light source 202; Δh is the surface height difference (Δh). The phase difference (Δφ) may be the difference in the phase (φ) between the edge exclusion position (X0) and the reference area 106. The equation (1) shows the phase difference (Δφ) approaching to 0 with the angle of incidence (θᵢ) at grazing incidence, meaning the system 200 may require a higher phase measurement resolution at grazing incidence to detect the surface height difference (Δh). The lateral shearing interferometer 206 may allow for the measurement of the edge roll-off 110 as the lateral displaced interference creates the phase difference (Δφ) representing the edge roll-off 110 as given by equation (1).

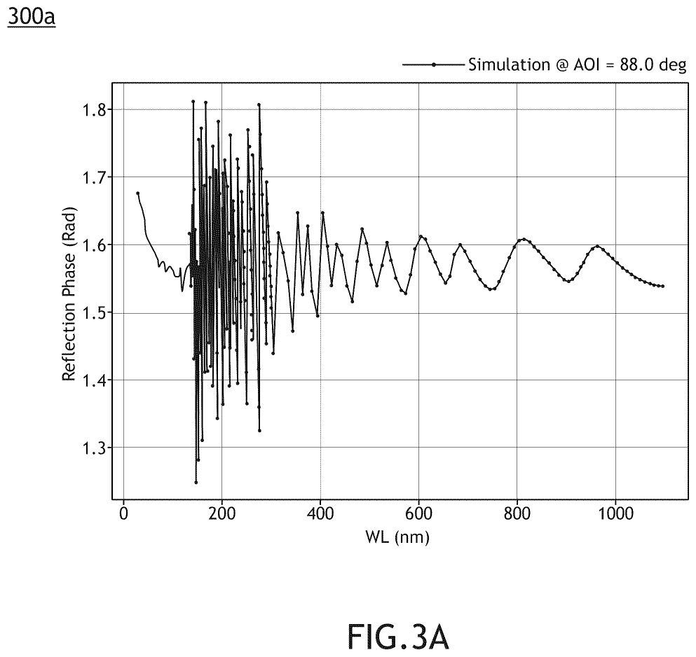

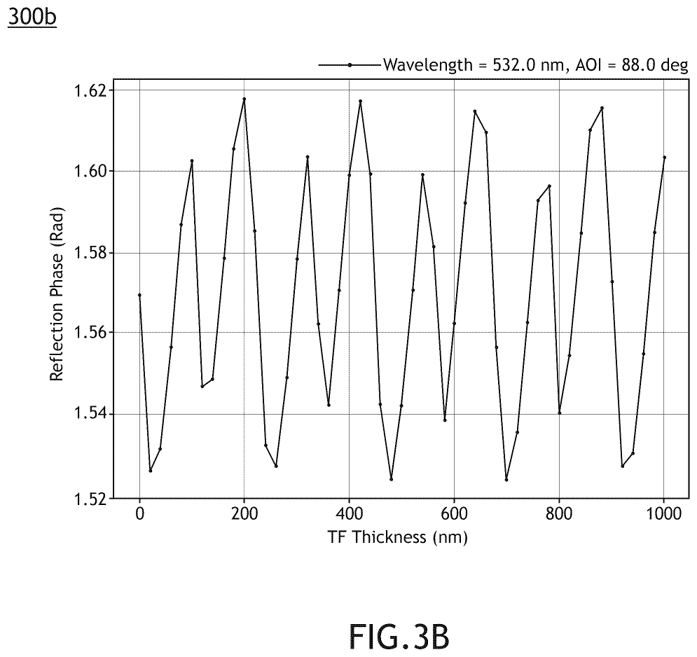

FIGS. 3A-3B illustrate graphs 300, in accordance with one or more embodiments of the present disclosure. The graphs 300 may be simulations of the system 200. The graphs 300 may be simulated for the illumination 207 having the unpolarized wavelength of 532 nm and the angle of incidence (θᵢ) at a grazing incidence angle of at 88 degrees, although this is not intended to be limiting. The graphs 300 may include a graph 300a and a graph 300b. In this simulation, the middle value of the phase (φ) of the reflected light 209 is at π/2. For example, because the reflected light 209 reflects from the sample 100, there is a π/2 phase offset assuming the surface profile 108 is perfectly flat such that no information is encoded in the reflected light 209. When changing the wavelength (λ) of the illumination 207 or the thickness of the thin-film 112, a coherence condition of the reflected light 209 may be changed causing a phase (φ) variation in the reflected light 209. The phase (φ) variation may change from construction to destructive interference.

The graph 300a may illustrate the phase (φ) of the reflected light 209 (e.g., reflection phase) in radians as a function of the wavelength (λ) of the illumination 207 in nanometers, where the reflected light 209 is reflected from 1 μm of SiO2 the thin-film 112 on the sample 100. The phase (φ) of the reflected light 209 is within the range of +/−0.3 radians in the wavelength range of 400-1000 nm, which converted to the range of vertical displacement error of about 60 nm using equation (1). The graph 300a illustrates that the phase (+) of the reflected light 209 may be changed by adjusting the wavelength (λ) of the illumination 207. The wavelength (λ) of the illumination 207 may change the phase (φ) of the reflected light 209 up and down.

The graph 300b may illustrate the phase (φ) of the reflected light 209 (e.g., reflection phase) in radians as a function of the thickness of the thin-film 112 in nanometers underneath the surface 102 of the sample 100, where the thin-film 112 has different thicknesses of oxide of the thin-film 112 on the sample 100. The phase (φ) of the reflected light 209 from SiO2 of the thin-film 112 at grazing incidence is within +/−0.05 radians independent of SiO₂ thickness. The thickness of the thin-film 112 may change the phase (φ) of the reflected light 209 up and down. The phase (φ) variation of +−0.05 radians uncertainty when changing the thickness of the thin-film 112 may require compensation to enable accurately reconstructing the surface profile 108 during runtime. In this example, the phase (φ) variation of 0.05 radians may result in about 6 nm in error when reconstructing the surface profile 108.

The controller 212 may cause the system 200 to compensate for the thickness of the thin-film 112 when reconstructing the surface profile 108. The controller 212 may cause the system 200 to compensate for the thickness of the thin-film 112 without knowing the thickness of the thin-film 112. The controller 212 may cause the system 200 to compensate for the thickness of the thin-film 112 when reconstructing the surface profile 108 by adjusting the wavelength (λ) of the illumination 207 as the detector 210 generates the images 213 and averaging the phase (φ) of the reflected light 209 from the images 213 when reconstructing the phase (φ). The controller 212 may adjust the wavelength (λ) of the illumination 207 via the light source 202 and/or the illumination optics 218. Averaging the phase (φ) of the reflected light 209 from the images 213 may remove the phase (φ) variation caused by the thickness of the thin-film 112.

The controller 212 adjust the illumination 207 for single, multiple wavelengths, or a wavelength bandwidth for the optimizing the measurement of the surface profile 108. Optimization of the wavelength of the illumination 207 may include single wavelength selection, wavelength band width and distribution, multiple wavelengths, and the like. The controller 212 adjust the wavelength from the ultraviolet region to the infrared region. The combination of multiple wavelengths or certain range of broadband through the optimization and selection process may allow measuring the surface profile 108 and the edge roll-off 110 with better resolution, precision, stability, accuracy, and system-to-system matching.

The controller 212 may adjust the wavelength (λ) of the illumination 207 as the detector 210 generates the images 213 using the time-domain reconstruction 221 and/or the spatial reconstruction 219. For example, the system 200 may generate the images 213 when adjusting the wavelength (λ) of the illumination 207 and then cause the grating actuator 220 to laterally shift the grating 208 between generating the images 213 during the time-domain reconstruction 221. It may be advantageous to adjust the wavelength (λ) through the full range at each lateral shift, to avoid registration errors. The phase (φ) of the reflected light 209 may then be reconstructed by the time-domain reconstruction 221 and averaged across each of the wavelength (λ) of the illumination 207.

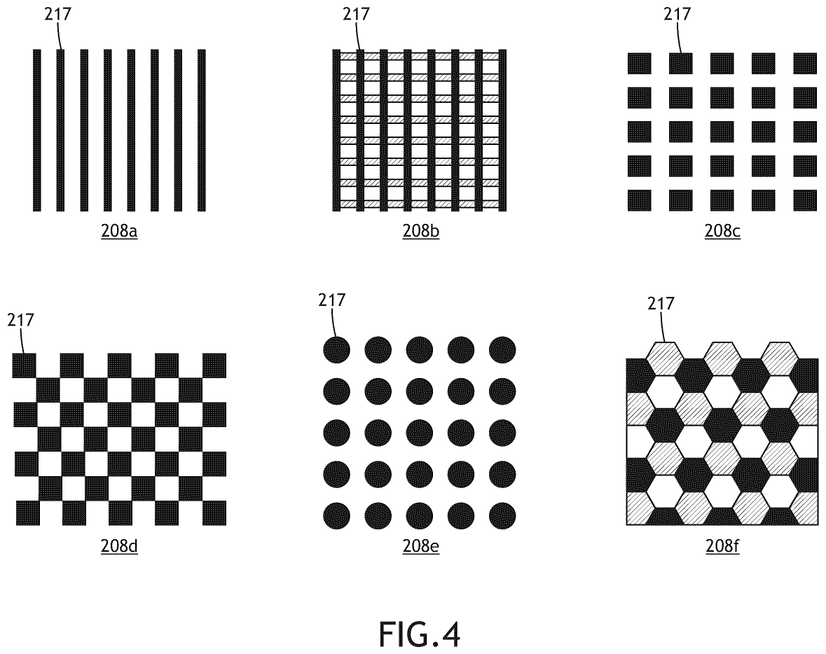

FIG. 4 illustrates the grating 208, in accordance with one or more embodiments of the present disclosure. The grating 208 may include any suitable pattern. The grating 208 may be a one-dimensional diffraction grating or a two-dimensional diffraction grating. For example, the grating 208 may be a one-dimensional diffraction grating 208a, a two-dimensional diffraction grating 208b, a two-dimensional diffraction grating 208c, a two-dimensional diffraction grating 208d, a two-dimensional diffraction grating 208e, and/or a two-dimensional diffraction grating 208f. The one-dimensional diffraction grating 208a may be used with the detector 210 configured as the one-dimensional detector. Any of the various two-dimensional diffraction gratings may be used with the detector 210 configured as the two-dimensional detector.

The one-dimensional diffraction grating 208a may also be referred to as a line grating. The one-dimensional diffraction grating 208a may diffract the reflected light 209 as the diffracted light 211 in one direction. The controller 212 may reconstruct the phase difference (Δφ) from the images 213 and measure the edge roll-off 110 in one direction (e.g., at one point along the edge 104).

Any of the various two-dimensional diffraction gratings may reconstruct the phase difference (Δφ) in two dimensions to measure the vertical displacements in both X/Y or radial/theta directions. The two-dimensional diffraction grating 208b may also be referred to as a square pinhole-array diffraction grating. The two-dimensional diffraction grating 208b may be formed by the diffracting elements 217 shaped as lines which are oriented orthogonally to each other to form square pinholes arranged in a square lattice. The two-dimensional diffraction grating 208c may be formed by the diffracting elements 217 shaped as squared which are arranged in a square lattice. The two-dimensional diffraction grating 208d may also be referred to as a checkerboard diffraction grating. The two-dimensional diffraction grating 208d may be formed by the diffracting elements 217 shaped as squares arranged in a centered rectangular lattice. The two-dimensional diffraction grating 208e may be formed by the diffracting elements 217 shaped as circles arranged in a square lattice. The two-dimensional diffraction grating 208f may also be referred to as a hexagonal diffraction grating. The two-dimensional diffraction grating 208e may be formed by the diffracting elements 217 shaped as hexagons and arranged in a hexagonal lattice.

Each of the designs of the grating 208 may define a line/space ratio. The line/space ratio may be defined by the grating period and the spatial frequency of diffracting elements 217 of the grating 208. The line/space ratio may be any suitable value, such as, but not limited to, 50% line/space ratio (e.g., half line/half space). The 50% line/space ratio may cancel the 2nd order of the diffracted light 211 and get rid of the interference impact of the 2nd order with 1st or 3rd orders.

The grating 208 may include a select pitch (T). The pitch (T) of the grating 208 may be determined by the required resolution of the lateral shearing interferometer 206, resolution of the detector 210, distance between the detector 210 and the sample 100, and/or the angle of incidence (θᵢ). The pitch (T) of the grating 208 may be calculated as:

$$T = \frac{λ d}{s \cdot cos {θ}_{i}} \qquad ( 2 )$$

where d is the distance from the detector 210 to the wafer surface; θᵢ is the angle of incidence (θᵢ); A is the wavelength of the light source 202; s is the shear amount(s) used in LSI measurement. Assuming d of 30 mm, λ of 405 nm, θ of 88 degrees and s of 5 mm, T is calculated to be 69.6 um.

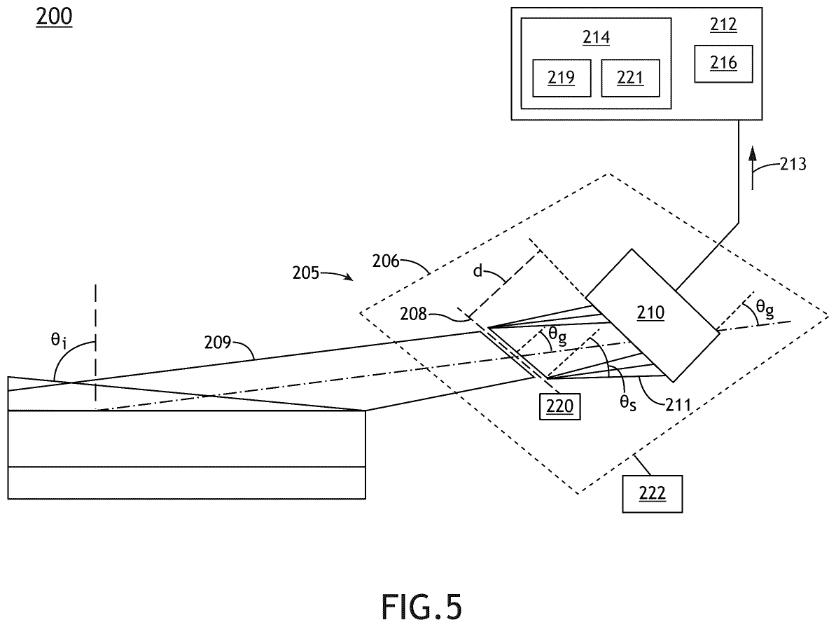

FIG. 5 illustrates a partial view of the system 200, in accordance with one or more embodiments of the present disclosure. The system 200 may include the LSI actuator 222. The LSI actuator 222 may rotate the lateral shearing interferometer 206, the grating 208, the detector 210, and/or the grating actuator 220. For example, the LSI actuator 222 may rotate together the grating 208 and/or the detector 210. The grating 208 and the detector 210 may be configured to rotate together relative to the angle of incidence (θᵢ) of the illumination 207 and/or the reflected light 209. For example, the grating 208 and detector 210 may be rotated at a tilt angle (Og) with respect to the angle of incidence (θᵢ). The grating 208 and the detector 210 may be rotated at normal incidence to the reflected light 209 to an angle that is not at normal incidence to the reflected light 209. The grating 208 may be disposed at a distance (d) to the detector 210. The diffracted light 211 may diffracted at a scattered angle(es). The scattered angle(es) may be the first order scattering of the diffracted light 211.

Rotating the grating 208 and the detector 210 can increase the spatial resolution of the images 213 on the detector 210 but may change the shear. Geometrically, the shear mapping(s) on the edge 104 can be determined by the following equation:

$$s = d ( tan {θ}_{s} - tan {θ}_{g} ) / cos ( {θ}_{i} - {θ}_{g} ) , where sin {θ}_{s} = sin {θ}_{g} + λ / T \qquad ( 3 )$$

where θᵢ is the angle of incidence (θᵢ) of the illumination 207 on the sample 100, θ_{g} is the angle of incidence (θ_{g}) of the reflected light 209 on the grating 208, and θₛ is scattered angle (θₛ) of the 1st order of the diffracted light 211. For normal incidence to the grating 208 scenario as shown in FIG. 2, θ_{g}=0. Equation (3) can be simplified to Equation (2).

The controller 212 may cause the LSI actuator 222 to rotate the grating 208 and/or the detector 210 as the detector 210 generates the images 213. The controller 212 may to rotate the grating 208 and the detector 210 together relative to the reflected light 209 to achieve a higher pixel resolution for shearing on the images 213.

The controller 212 may calibrate the angle of incidence (θᵢ) of the illumination 207. The angle of incidence (θᵢ) of the illumination 207 may scale the phase by cos (θᵢ) in Equation (1), thus the system 200 may be calibrated with high resolution. For the angle of incidence (θᵢ) at grazing incidence, the cos (θᵢ)≈0 and sin (θᵢ)≈1. Then the reflectance of S-polarized reflectance (Rₛ) and P-polarized reflectance (Rₚ) from the Fresnel equation can be approximated as:

$${R}_{s} = 1 - \frac{4 cos {θ}_{i}}{\sqrt{{n}^{2} - 1}} \qquad ( 4 )$$

$${R}_{p} = 1 - \frac{4 {n}^{2} cos {θ}_{i}}{\sqrt{{n}^{2} - 1}} \qquad ( 5 )$$

where n is the refractive index (n) of the surface 102. For example, the refractive index (n) of the surface 102 may be the refractive index of the thin-film 112. With the above equations, the controller 212 may measure the S-polarized reflectance (Rₛ) and P-polarized reflectance (Rₚ). The S-polarized reflectance (Rₛ) and P-polarized reflectance (Rₚ) may be the measurement of the diffracted light 211 which is S-polarized and P-polarized, respectively. The S-polarized reflectance (Rₛ) and P-polarized reflectance (Rₚ) may be measured from a calibration sample (e.g., a SiO2 calibration wafer). The controller 212 may cause the system 200 to angle of incidence (θᵢ) at different grazing incidences. The controller 212 may fit the S-polarized reflectance (Rₛ) and P-polarized reflectance (Rₚ) for the angle of incidence (θᵢ) at different grazing incidences to calibrate the refractive index (n) and the angle of incidence (θᵢ). Calibrating the angle of incidence (θᵢ) through measured reflectivity with different polarization may increase the resolution when measuring the surface profile 108.

The lateral shearing interferometer 206 may measure S-polarized reflectance (Rₛ) and P-polarized reflectance (Rₚ) of the diffracted light 211 and measure the refractive index (n) of the surface 102 and the angle of incidence (θᵢ) from the S-polarized reflectance (Rₛ) and P-polarized reflectance (Rₚ). The controller 212 may measure the profile of the refractive index (n) across the surface 102 of the sample 100. For the system 200 with the angle of incidence (θᵢ) calibrated, the surface profile 108 collected from the S-polarized reflectance (Rₛ) and P-polarized reflectance (Rₚ) at the grazing angle in the system 200 may be used to measure the profile of the refractive index (n) across the surface 102. The angle of incidence (θᵢ) may be calibrated by the controller 212 through measured reflectivity with different polarizations (e.g., the S-polarized reflectance (Rₛ) and P-polarized reflectance (Rₚ)). The controller 212 may also measure the refractive index (n) of the thin-film 112 on the surface 102 of the sample 100 through the measured reflectivity with the different polarizations.

The controller 212 may also adjust a polarization of the illumination 207. The controller 212 may also adjust the polarization of the illumination 207 using the light source 202 and/or the illumination optics 218. Due to different reflectivity and reflectivity sensitivity against the angle of incidence (θᵢ) between S-polarized and P-polarized light of the illumination 207 in the reflected light 209, the controller 212 may adjust the polarization of the illumination 207 by the illumination optics 218. For example, the controller 212 may measure the S-polarized reflectance (Rₛ) and P-polarized reflectance (Rₚ) and adjust the S-polarized and P-polarized light of the illumination 207.

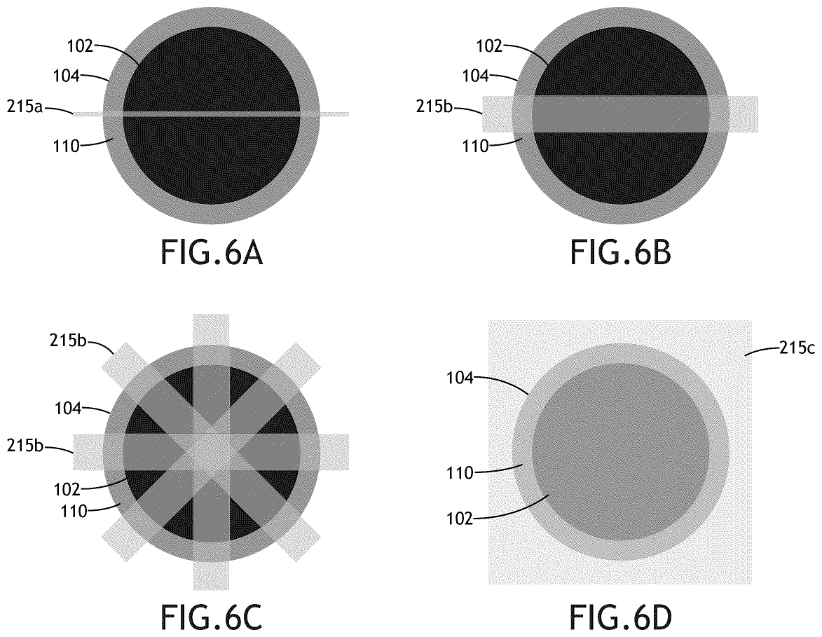

FIG. 6A-6D illustrate top views of the sample 100 with the illumination 207 landing on the sample 100 with the beam width 215, in accordance with one or more embodiments of the present disclosure. The beam width 215 may be a line beam 215a, a rectangular beam 215b, and/or a full-sample beam 215c. The controller 212 may adjust the beam width 215 of the illumination 207. For example, the controller 212 may adjust the beam width 215 of the illumination 207 between the line beam 215a, the rectangular beam 215b, and/or the full-sample beam 215c. The controller 212 may adjust the beam width 215 by the light source 202 and/or the illumination optics 218. The controller 212 may adjust the beam width 215 based on the measurement of the surface profile 108 and the edge roll-off 110.

The controller 212 may make a full measurement of the surface profile 108 across the surface 102 and/or a 360-degree measurement of the edge roll-off 110 around the edge 104 (e.g., hereafter full measurements). The controller 212 may make the 360-degree measurement of the edge roll-off 110 around the edge 104 by causing the stage 204 to rotate the sample 100 to multiple angles about a normal axis relative to the illumination 207 when generating the images 213. The 360-degree measurement of the edge roll-off 110 may provide comprehensive information of the edge roll-off 110 and complete edge bonding control in wafer bonding process. The controller 212 may make the full measurements by multiple measurements using the line beam 215a and/or the rectangular beam 215b with the controller 212 causing the stage 204 to rotate the sample 100 to multiple angles about the normal axis relative to the illumination 207. The rotation of the sample 100 may enable the sample 100 to be measured at any rotation angle and up to full edge coverage in the surface profile 108 and the edge roll-off 110 measurement. The controller 212 may also make the at different angles or one time measurement with the full-sample beam 215c without rotating the sample 100 about the normal axis.

FIG. 6A illustrates the line beam 215a on the sample 100, in accordance with one or more embodiments of the present disclosure. The line width of the line beam 215a may be between 1 μm and 1 mm. The line beam 215a may encode the surface profile 108 in a line along the line beam 215a. The line beam 215a may also encode the edge roll-off 110 at two points on the edge 104, the two points being at opposing ends of the line beam 215a. The edge roll-off 110 measured from the lateral shearing interferometer 206 is the edge roll-off 110 along the line in X-direction. The grating 208 may be the one-dimensional diffraction grating 208a and the detector 210 may be the one-dimensional detector when the system 200 generates the line beam 215a.

FIG. 6B illustrates the rectangular beam 215b on the sample 100, in accordance with one or more embodiments of the present disclosure. The rectangular beam 215b may be wider than the line beam 215a. The rectangular beam 215b may cover more area of the surface 102 and encode more of the edge roll-off 110 of the edge 104 than the line beam 215a. The edge roll-off 110 measured may be average ERO along the line in X-direction if the grating 208 is the one-dimensional grating and the detector 210 is the one-dimensional detector. Alternatively, the edge roll-off 110 may be a two-dimensional ERO in the region illuminated by the rectangular beam 215b by the grating 208 being one of two-dimensional gratings and the detector 210 being the two-dimensional detector so that two-dimensional ERO in both X and Y directions can be obtained. The two-dimensional ERO can be also described as in radial and theta direction for better process control and process characterization such as chemical-machine polishing.

It is noted that the rectangular beam 215b may land on the surface 102 with a rectangular profile (e.g., to encode the edge roll-off into the full width of the rectangular beam 215b). However, the ends of the rectangular beam 215b which extend beyond the sample 100 may or may not be rectangular. For example, the profile of the rectangular beam 215b may be a rectangular shape, a stadium shape, or the like. The term rectangular in the rectangular beam 215b is meant to refer to the shape of the rectangular beam 215b landing on the surface 102.

FIG. 6C illustrates the rectangular beam 215b on the sample 100, in accordance with one or more embodiments of the present disclosure. The controller 212 may cause the stage 204 to rotate the sample 100 to multiple angles about the normal axis relative to the rectangular beam 215b. The rotation may enable the controller 212 to measure the full measurement of the surface profile 108. As depicted, six of the rectangular beam 215b may land on the sample 100 during the rotation of the sample 100, although this is not indented to be limiting. If a 20 mm illumination width is used, 24 measurements may be used to cover the 300 mm wafer in measuring the edge roll-off 110.

FIG. 6D illustrates the full-sample beam 215c on the sample 100, in accordance with one or more embodiments of the present disclosure. The full-sample beam 215c may be wider than the line beam 215a and the rectangular beam 215b. The controller 212 may measure the full measurement of the surface profile 108 using the full-sample beam 215c. The edge roll-off 110 may be a two-dimensional ERO in the region illuminated by the full-sample beam 215c by the grating 208 being one of two-dimensional gratings and the detector 210 being the two-dimensional detector so that two-dimensional ERO in both X and Y directions can be obtained. The full-sample beam 215c may have a beam width of more than 300 mm in combination with the width of the grating 208 and the detector 210 being more than 300 mm. The full-sample beam 215c may be advantageous to improve a higher throughput than the rectangular beam 215b, at the expense of requiring a larger beam width, grating, and detector.

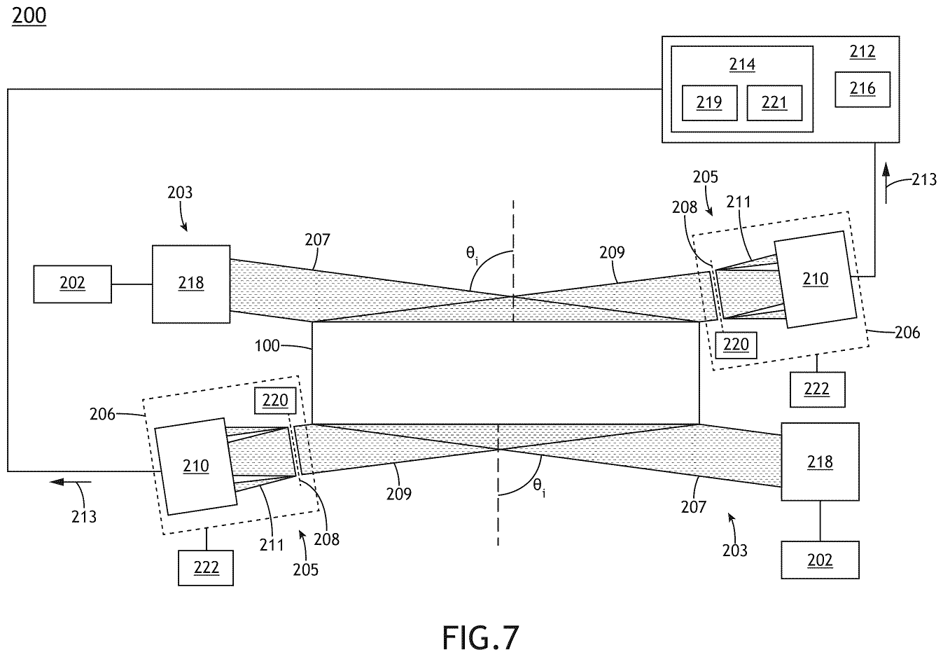

FIG. 7 illustrates the system 200, in accordance with one or more embodiments of the present disclosure. The system 200 may be configured for both frontside surface metrology and backside surface metrology. The system 200 measure the surface profile 108 including the edge roll-off 110 of for one or both of the surfaces 102 of the sample 100. The system 200 may include pairs of the light source 202, the illumination path 203, the stage imaging path 205, the lateral shearing interferometer 206, the illumination 207, the grating 208, the reflected light 209, the detector 210, the diffracted light 211, the images 213, and the illumination optics 218, where a first of the pairs is used for a first of the surfaces 102 and a second of the pairs is used for the second of the surfaces 102. The controller 212 may receive the images 213 from the detectors 210 and simultaneously measure the surface profile 108 for both of the surfaces 102. Simultaneously measuring the surface profile 108 for both of the surfaces 102 may increase a throughput of the system 200.

The stage 204 may support the sample 100 out of the illumination path 203 and/or the imaging path 205 of the lateral shearing interferometers 206. For example, the sample 100 may be horizontal placed on the stage 204 or be vertically oriented with the edge 104 clamped by the stage 204. The measurement of the surface profile 108 and the edge roll-off 110 may be implemented for one or both of the surfaces 102 with the sample 100 placed either horizontally, vertically, or an angle therebetween. The advantages of vertical placed wafers in measurement of the surface profile 108 include the measurement resolution and stability with less adverse impact from gravity and chucking uncertainty in addition to the measurement of the surface profile 108 of both the frontside and backside of the sample 100. The implementation may be useful when the process is intended to do on backside or both sides of the sample 100. The system 200 allows to be implemented to measure the surface profile 108 including the edge roll-off 110 of one side with wafer horizontally placed on the stage 204 or both sides with wafer vertically placed or clamped.

Referring generally again to the figures. The system 200 may be used for high and low end of wafer bonding, also all the other metrology needs for the process control on the surface profile 108 including the edge roll-off 110. The high-resolution of the measurement of the surface profile 108 provided by the system 200 may target the ever-demanding metrology needs for low ERO wafers used in backside power distribution network (BS-PDN) process with device wafers being bonded onto another carrier wafer like silicon and glass wafer. The other potential wafer bonding process requiring low ERO control is 4F2 (square) DRAM fabrication which has a vertical cell transistor. In one kind of process flow of 4F2 DRAM, Bit line is made first on the top of vertical transistor and the capacitor on the other end of the transistor after wafer bonding on a carrier wafer and wafer polishing back. The bonding quality is strongly depending on wafer edge roll-off within edge region such as 5 mm or less. Wafer edge rebuilding process, including multiple steps of edge deposition and edge etch or trim process, is needed to fine tune wafer edge roll-off for the best bonding quality. The lateral shearing interferometer 206 may be implemented with the angle of incidence (θᵢ) at grazing incidence, with optimal wavelength and polarization selections for the illumination 207, thus can be used for the wafer surface, wafer edge monitoring and relevant wafer edge process control on product wafers including the most demanding wafer bonding in the process such as BS-PDN and 4F2 DRAM.

The lateral shearing interferometer 206 may be a common path interferometer. The common path interferometer may provide a passive reduction of errors by using common path configuration, such that a reference and object path are almost entirely overlapping. The common path interferometer may make the lateral shearing interferometer 206 ideal for testing set-ups on poorly stabilized environments and other adverse experimental conditions. The common path interferometer may enable measuring the surface profile 108 and the edge roll-off 110. The common path property may allow the lateral shearing interferometer 206 to accept very low coherent light. Less coherent light may improve the resolution when measuring the edge roll-off 110, because the less coherent light may remove the coherent noise. The system 200 may be resistant to vibration and environmental impacts due to the lateral shearing interferometer 206 being the common path interferometer. The system 200 may enable measuring the edge roll-off 110 measurement capability for the sample 100 with the thin-film 112, for the sample 100 with pattern structures under the thin-film 112, or the like.

The lateral shearing interferometer 206 may be configured to perform interferometry for any of the wavelengths of the illumination 207. For example, the grating 208 may diffract any of the various wavelengths. By way of another example, the detector 210 may detect any of the wavelengths. The wavelengths may encode the height in different scaling factor or lateral displacement. The scaling factor can be accommodated for in the reconstruction by the controller 212.

The system 200 may provide optical measurements of the surface profile 108. The system 200 may be a non-contact system. For example, the system 200 may measure the surface profile 108 without contacting the surface 102. Not contacting the surface 102 may be beneficial to prevent damaging the surface 102.

The illumination optics 218 and/or the imaging optics may include any suitable optics, such as, but not limited to lenses, irises, variable beam expanders, polarizers, filters, beam splitters, diffusers, homogenizers, apodizers, stops, fibers, mirrors, prisms, additional gratings, or the like.

The grating 208 may be disposed at a select distance from the sample 100. When the illumination 207 reflects off the sample 100 as the reflected light 209, the edge roll-off 110 may be encoded into the phase (φ) of the reflected light 209 as low frequency information. The sample 100 may also encode the structure underneath the surface 102 into the phase (φ) of the reflected light 209 as high frequency information. The distance may be controlled to pass the low frequency information and reject the high frequency information.

The grating 208 may be disposed at a select distance from the detector 210. The distance between the grating 208 and the detector 210 may control the diffraction of the diffracted light 211 on the detector 210. For example, the reflected light 209 may diffract from the grating 208 as the diffracted light 211 with a fixed angle. As the distance between the grating 208 and the detector 210 increases, the diffracted light 211 may be diffracted further apart to change the position of the edge exclusion position (X0) and/or the reference area 106.

The system 200 may include additional of the lateral shearing interferometers 206 for either or both of the surfaces 102 to generate additional of the images 213. The lateral shearing interferometers 206 may be above and below the sample 100, both above the sample 100 (not depicted), or both below the sample 100 (not depicted).

It is noted that the system 200 may use all of the various techniques in combination or separately. For example, the controller 212 reconstruct the phase (φ) of the reflected light 209 using the spatial reconstruction 219 and/or a time-domain reconstruction 221, the controller 212 may cause the system 200 to compensate for the thickness of the thin-film 112 when reconstructing the surface profile 108, use any of the designs for the grating 208, the controller 212 may cause the LSI actuator 222 to rotate the lateral shearing interferometer 206 at the at the tilt angle (θ_{g}), the controller 212 may calibrate the angle of incidence (θᵢ) of the illumination 207, the controller 212 may measure the profile of the refractive index (n) across the surface 102, the controller 212 may generate the full measurement of the surface profile 108 across the surface 102, the system 200 may include the pairs of the lateral shearing interferometers 206, and the like in combination or separately.

The system 200 may have high resolution on measurement of the surface profile 108 including the edge roll-off 110. The resolution may also be referred to as measurement accuracy. The system 200 may include a select resolution. The resolution of measuring the surface profile 108 including the edge roll-off 110 may be sub-micrometer (e.g., on the order of single digit nanometer, tens of nanometers, or hundreds of nanometers). For example, the system 200 may have 10 nm resolution or below. The system 200 may measure the surface profile 108 and the edge roll-off 110 with resolution of 10 nm or below on the sample 100. The time-domain reconstruction 221, the illumination 207 being the ultraviolet light, and/or the calibration of the angle of incidence (θᵢ) of the illumination 207 in combination may enable the resolution of 10 nm or below. The lateral shearing interferometer 206 may be used for advanced semiconductor process control of the surface profile 108, particularly the edge roll-off 110 down to sub-micrometer level to reduce wafer edge related device yield loss and performance degradation. The system 200 may measure the edge roll-off 110 with high resolution down to 10 nm or below with minimum impact from the thin-film 112, transparent or translucent, on the sample 100. The lateral shearing interferometer 206 may measure the surface profile 108 including the edge roll-off 110 with high resolution and free of adverse impact by the thin-film 112, transparent and translucent, on the sample 100.

Although the system 200 is described as including the grating 208, this is not intended as a limitation of the present disclosure. Besides the grating 208, 1D or 2D, the other methods to generate resolve the difference by generating the interference pattern may include Zoneplate, holographic plate, Shack-Hartmann wavefront sensor, QWLSI (Quadriwave lateral shearing interferometer), Fizeau interferometer, lateral differential interferometry, and other interferometry methods.

The one or more processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program. Moreover, different subsystems of the system may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers.

In embodiments, a controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive, and the like. The memory medium may include flash memory cells, or other type memory, discrete EPROM or EEPROM, or the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet, and the like).

As used throughout the present disclosure, the term “substrate” generally refers to a substrate formed of a semiconductor or non-semiconductor material (e.g., thin filmed glass, or the like). For example, a semiconductor or non-semiconductor material may include, but is not limited to, monocrystalline silicon, gallium arsenide, indium phosphide, or a glass material. A substrate may include one or more layers. For example, such layers may include, but are not limited to, a resist (including a photoresist), a dielectric material, a conductive material, and a semiconductive material. Many different types of such layers are known in the art, and the term sample as used herein is intended to encompass a substrate on which all types of such layers may be formed. One or more layers formed on a substrate may be patterned or un-patterned. For example, a substrate may include a plurality of dies, each having repeatable patterned features. Formation and processing of such layers of material may ultimately result in completed devices. Many different types of devices may be formed on a substrate, and the term substrate as used herein is intended to encompass a substrate on which any type of device known in the art is being fabricated. Further, for the purposes of the present disclosure, the term substrate and wafer should be interpreted as interchangeable. In addition, for the purposes of the present disclosure, the terms patterning device, mask, and reticle should be interpreted as interchangeable.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all its material advantages. The form described is merely explanatory, and it is the intention of the following claims to encompass and include such changes. Furthermore, it is to be understood that the invention is defined by the appended claims.

What is claimed:

1. A system comprising:
a light source configured to generate illumination, wherein the illumination is directed to a sample along an illumination path and lands on a surface of the sample at an angle of incidence, wherein the angle of incidence is at grazing incidence, wherein the illumination reflects from the sample as reflected light encoding a surface profile of the surface in a phase of the reflected light, wherein the surface profile includes an edge roll-off of an edge of the sample;
a stage configured to support the sample;
a lateral shearing interferometer comprising:
a grating, wherein the reflected light is directed from the sample to the grating along an imaging path, wherein the grating diffracts the reflected light as diffracted light; and
a detector, wherein the diffracted light is directed from the grating to the detector along the imaging path, wherein the detector is configured to generate images of the diffracted light; and
a controller, wherein the controller comprises one or more processors and memory, wherein the one or more processors are configured to execute program instructions maintained on the memory causing the controller to:
receive the images from the detector; and
measure the surface profile and the edge roll-off by reconstructing the phase of the reflected light from the images.

2. The system of claim 1, wherein the sample is a wafer.

3. The system of claim 2, wherein the wafer is one of a BS-PDN wafer or a 4F2 DRAM wafer.

4. The system of claim 1, wherein a wavelength of the illumination is at least one of an ultraviolet wavelength, a visible wavelength, or an infrared wavelength.

5. The system of claim 1, wherein the illumination is collimated when landing on the sample.

6. The system of claim 1, wherein the angle of incidence is between 80 degrees and 89.5 degrees.

7. The system of claim 6, wherein the angle of incidence is calibrated by the controller through measured reflectivity with different polarizations.

8. The system of claim 7, wherein the controller is configured to measure a refractive index of a thin-film on the surface of the sample through the measured reflectivity with different polarizations.

9. The system of claim 1, wherein the illumination lands on the sample and extends across a length of the sample between opposing sides of the edge of the sample.

10. The system of claim 1, wherein at least 90% of the illumination reflects as the reflected light from the surface.

11. The system of claim 1, wherein the grating is one of a transmissive grating or a reflective grating.

12. The system of claim 11, wherein the grating is the transmissive grating.

13. The system of claim 1, wherein the controller is configured to reconstruct the phase of the reflected light from the images using a spatial reconstruction.

14. The system of claim 1, wherein the controller is configured to reconstruct the phase of the reflected light from the images using a time-domain reconstruction, wherein the lateral shearing interferometer comprises a grating actuator, wherein the controller is configured to cause the grating actuator to laterally shift the grating between generating the images.

15. The system of claim 1, wherein the controller is configured to measure the surface profile of the sample using the phase based on a phase difference between an edge exclusion position and a reference area of the sample.

16. The system of claim 1, wherein the controller is configured to compensate for a thickness of a thin-film disposed under the surface when reconstructing the surface profile by adjusting a wavelength of the illumination as the detector generates the images.

17. The system of claim 1, wherein the grating is one of a one-dimensional diffraction grating or a two-dimensional diffraction grating.

18. The system of claim 1, wherein the system comprises an LSI actuator, wherein the LSI actuator is configured to rotate the lateral shearing interferometer at a tilt angle with respect to the angle of incidence.

19. The system of claim 1, wherein the controller is configured to measure an S-polarized reflectance and a P-polarized reflectance of the diffracted light and measure a refractive index of the surface and the angle of incidence (θᵢ) from the S-polarized reflectance and P-polarized reflectance.

20. The system of claim 1, wherein the illumination is configured to land on the sample with a beam width, wherein the beam width is at least one of a line beam, a rectangular beam, or a full-sample beam.

21. The system of claim 20, wherein the beam width is at least one of the line beam or the rectangular beam, wherein the controller is configured to make a 360-degree measurement of the edge roll-off around the edge by causing the stage to rotate the sample to multiple angles about a normal axis relative to the illumination when generating the images.

22. The system of claim 20, wherein the beam width is the full-sample beam, wherein the controller is configured to make a 360-degree measurement of the edge roll-off around the edge.

23. The system of claim 1, wherein the surface is a top surface, the system comprising a second lateral shearing interferometer, wherein the second lateral shearing interferometer is configured to measure the edge roll-off of a bottom surface of the sample.

24. The system of claim 1, wherein the controller is configured to measure the edge roll-off with a resolution of sub-micrometers.

25. The system of claim 24, wherein the controller is configured to measure the edge roll-off with a resolution of 10 nm or below.
